(19) United States
(12) Patent Application Publication
(10) Pub. No.: US 2008/0293849 A1
(43) Pub. Date: Nov. 27, 2008

(54) Nanocomposite Material Comprising Rubber and Modified Layered Double Hydroxide, Process for Its Preparation and Use Thereof

(75) Inventors: Robin Winters, Bemmel (NL); Haimo Tonnaer, Deventer (NL); Elwin Schomaker, Arnhem (NL)

Correspondence Address: KENYON & KENYON LLP, ONE BROADWAY, NEW YORK, NY, 10004, US

(73) Assignee: VELPERWEG 76, Arnhem (NL)

(21) Appl. No.: 12/096,455

(22) PCT Filed: Dec. 1, 2006
(86) PCT No.: PCT/EP06/69206

§ 371 Date: Jun. 23, 2008

Related U.S. Application Data
(60) Provisional application No. 60/810,628, filed on Jun. 5, 2006.

(30) Foreign Application Priority Data
Dec. 6, 2005 (EP) 05111752.1
Dec. 22, 2005 (EP) 05112777.7
Apr. 18, 2006 (EP) 06112709.8

(51) Int. Cl. C08J 3/22; C08F 36/00; C08F 36/06; C08L 21/00

(52) U.S. Cl. 523/351; 526/335; 528/10

(57) ABSTRACT

The present invention pertains to a nanocomposite material comprising rubber and a modified layered double hydroxide comprising: a charge-balancing organic ion having a first functional group and a second functional group, wherein at least part of the organic anions is chemically linked to the rubber through the second functional group; and/or a silane coupling agent having at least one alkoxysilane group and at least one reactive group, at least one alkoxysilane group being chemically linked to the layered double hydroxide, at least one reactive group being chemically linked to the rubber. The invention further pertains to a process for preparing the nanocomposite material or a precursor thereof.

The invention relates to a process for preparing nanocomposite materials comprising a polymer and a modified layered double hydroxide. The invention further pertains to nanocomposite materials produced with the process.

Processes for preparing nanocomposite materials are known in the art. WO 99/35185, U.S. Pat. No. 6,812,273, DE 198 36 580, and US 2003/0114699 disclose the use of an organically modified layered double hydroxide in various polymeric matrices. However, none of these references mentions that the polymeric matrix is a rubber.

JP 2004/284842 discloses the use of an LDH modified with a triazine dithiol and/or a trithiol compound in halogen-containing polymers. The triazine dithiol and trithiol compounds disclosed in this reference serve as a cross-linking agent, and they are particularly suitably used as cross-linking agents for halogen-containing polymers. These thiol compounds generally are not easily incorporated into the LDH and can only be used for a limited number of rubbers.

It is an object of the present invention to provide a nanocomposite material comprising rubber with improved physical properties.

This object is achieved with a nanocomposite material comprising rubber and a modified layered double hydroxide comprising:

a charge-balancing organic ion having a first functional group and a second functional group, wherein at least part of the organic anions is chemically linked to the rubber through the second functional group; and/or

a silane coupling agent having at least one alkoxysilane group and at least one reactive group, the alkoxysilane group being chemically linked to the layered double hydroxide, the reactive group being chemically linked to the rubber.

These nanocomposite materials have improved heat stability, better dimensional stability, improved tear strength, improved scratch resistance, increased flame resistance, and/or improved strength-to-weight ratios compared to conventional nanocomposite materials. The material furthermore reveals a reduced permeability towards gases and/or liquids, such as nitrogen, carbon dioxide, oxygen, water vapour, and hydrocarbons. The LDH present in the nanocomposite material of the invention may further adsorb and/or absorb additives or by-products of initiators used in the polymerization of the polymer. Additionally, the nanocomposite material of the invention exhibits improved elongation at break and strength at break compared to neat rubber material that does not comprise the clay of the invention. Furthermore, the rubber nanocomposite material exhibits better dynamic properties (e.g. a lower tan delta) during deformation at constant force, thus showing improved viscoelastic properties, which generally causes tyres comprising the rubber material to have a lower heat build-up and may result in a lower rolling resistance. The term “tan delta” is known to a skilled person, and is defined as the ratio of the loss modulus (G′) to the storage modulus (G″).

In the context of the present application the term “nanocomposite material” refers to a composite material wherein at least one component comprises an inorganic phase with at least one dimension in the 0.1 to 100 nanometer range. In addition, the term “rubber nanocomposite material” refers to a nanocomposite material comprising rubber.

In the context of the present application the term “charge-balancing organic ion” refers to organic ions that compensate for the electrostatic charge deficiencies of the crystalline LDH sheets. As the LDH typically has a layered structure, the charge-balancing organic ions may be situated in the interlayer, on the edge or on the outer surface of the stacked LDH layers. Such organic ions situated in the interlayer of stacked LDH layers are referred to as intercalating ions. LDHs treated with charge-balancing organic ions are rendered organophilic and are also referred to as “organoclays”.

Such a stacked LDH or organoclay may also be delaminated or exfoliated, e.g. in a polymeric matrix. Within the context of the present specification the term “delamination” is defined as reduction of the mean stacking degree of the LDH particles by at least partial de-layering of the LDH structure, thereby yielding a material containing significantly more individual LDH sheets per volume. The term “exfoliation” is defined as complete delamination, i.e. disappearance of periodicity in the direction perpendicular to the LDH sheets, leading to a random dispersion of individual layers in a medium, thereby leaving no stacking order at all.

Swelling or expansion of the LDHs, also called intercalation of the LDHs, can be observed with X-ray diffraction (XRD), because the position of the basal reflections—i.e. the d(00l) reflections—is indicative of the distance between the layers, which distance increases upon intercalation.

Reduction of the mean stacking degree can be observed as a broadening, up to disappearance, of the XRD reflections or by an increasing asymmetry of the basal reflections (00l).

Characterization of complete delamination, i.e. exfoliation, remains an analytical challenge, but may in general be concluded from the complete disappearance of non-(hk0) reflections from the original LDH.

The ordering of the layers and, hence, the extent of delamination, can further be visualized with transmission electron microscopy (TEM).

The LDH of the invention may be any LDH known to the man skilled in the art. Typically, these LDHs are mineral LDHs which are able to expand or swell. Such LDHs have a layered structure comprising charged crystalline sheets (also referred to as individual LDH layers) with charge-balancing anions sandwiched in between. The terms “expand” and “swell” in the context of the present application refer to an increase of the distance between the charged crystalline sheets. Expandable LDHs can swell in suitable solvents, e.g. water, and can be further expanded and modified by exchanging the charge-balancing ions with other (organic) charge-balancing ions, which modification is also known in the art as intercalation.

The modified layered double hydroxides, also referred to as LDHs, have a layered structure corresponding to the general formula:

└Mₘ²⁺Mₙ³⁺(OH)₂ₘ₊₂ₙ┘X_{n/z}^{z-}.bH₂O (I)

wherein M²⁺ is a divalent metal ion such as Zn²⁺, Mn²⁺, Ni²⁺, Co²⁺, Fe²⁺, Cu²⁺, Sn²⁺, Ba²⁺, Ca²⁺, and Mg²⁺, M³⁺ is a trivalent metal ion such as Al³⁺, Cr³⁺, Fe³⁺, Co³⁺, Mn³⁺, Ni³⁺, Ce³⁺, and Ga³⁺, m and n have a value such that m/n=1 to 10, and b has a value in the range of from 0 to 10. X can be any suitable anion known to the man in the art. Generally, X is an inorganic anion as exemplified below and/or an organic anion with or without second functional groups. In one embodiment of the invention, X is a charge-balancing organic ion having a first functional group and a second functional group or any other anion known to the man skilled in the art, as long as at least part of the intercalating ions is formed by the organic ion having a first functional group and a second functional group. Examples of other anions known in the art include hydroxide, carbonate, bicarbonate, nitrate, chloride, bromide, sulfonate, sulfate, bisulfate, vanadates, tungstates, borates, phosphates, pillaring anions such as HVO₄⁻, V₂O₇⁴⁻, HV₂O₁₂⁴⁻, V₃O₉³⁻, V₁₀O₂₈⁶⁻, Mo₇O₂₄⁶⁻, PW₁₂O₄₀³⁻, B(OH)₄⁻, B₄O₅(OH)₄²⁻, [B₃O₃(OH)₄]⁻, [B₃O₃(OH)₅]²⁻HBO₄²⁻, HGaO₃²⁻, CrO₄²⁻, and Keggin-ions. The other anions also include organic anions that do not comprise a second functional group, such as mono-, di- or polycarboxylic acids, phosphonic acids, sulfate acids, and sulfonic acids.

The LDHs of the invention include hydrotalcite and hydrotalcite-like anionic LDHs. Examples of such LDHs are hydrotalcite and hydrotalcite-like materials, meixnerite, manasseite, pyroaurite, sjögrenite, stichtite, barberonite, takovite, reevesite, and desautelsite. A preferred LDH is hydrotalcite, which is an LDH having a layered structure corresponding to the general formula:

└Mₘ²⁺Alₙ³⁺(OH)₂ₘ₊₂ₙ┘X_{n/z}^{z-}.bH₂O (II)

wherein m and n have a value such that m/n=1 to 10, preferably 1 to 6, and b has a value in the range of from 0 to 10, generally a value of 2 to 6, and often a value of about 4. X is a charge-balancing ion as defined above.

It is preferred that m/n should have a value of 2 to 4, more particularly a value close to 3.

The LDH may be in any crystal form known in the art, such as described by Cavani et al. (Catalysis Today, 11 (1991), pp. 173-301) or by Bookin et al. (LDHs and LDH Minerals, (1993), Vol. 41(5), pp. 558-564). If the LDH is a hydrotalcite, the hydrotalcite may be a polytype having 3H₁, 3H₂, 3R₁ or 3R₂ stacking, for example.

The distance between the individual LDH layers in an LDH-based organoclay generally is larger than the distance between the layers of a conventional LDH that did not contain organic anions in accordance with the invention, e.g. carbonate ions. Preferably, the distance between the layers in an LDH according to the invention is at least 1.0 nm, more preferably at least 1.5 nm, and most preferably at least 2 nm. The distance between the individual layers can be determined using X-ray diffraction, as outlined before.

The charge-balancing organic ion in accordance with the invention comprises a first functional group and a second functional group. The first functional group is an anionic group capable of interacting with the LDH. Examples of such first functional groups are carboxylate, sulfate, sulfonate, nitrate, phosphate, and phosphonate. The second functional group is capable of forming a chemical link with the rubber or rubber precursor. Examples of such second functional groups are acrylate, methacrylate, hydroxyl, chloride, bromide, amine, epoxy, thiol, vinyl, di- and polysulfides, carbamate, ammonium, sulfonic, sulfinic, sulfonium, phosphonium, phosphinic, isocyanate, hydride, imide, nitrosobenzyl, dinitrosobenzyl, phenol, acetoxy, and anhydride. The organic anion generally has at least 2 carbon atoms, preferably at least 6 carbon atoms, even more preferably at least 8 carbon atoms, and most preferably at least 10 carbon atoms, and generally at most 1,000 carbon atoms, preferably at most 500 carbon atoms, and most preferably at most 100 carbon atoms.

Suitable examples of organic anions in accordance with the invention include 8-amino octanoate, 12-amino dodecanoate, 3-(acryloyloxy) propanoate, 4-vinyl benzoate, 8-(3-octyl-2-axiranyl) octanoate, and unsaturated fatty acid-derived organic anions such as oleate and unsaturated tallow acid-derived anions.

It is also contemplated to use LDHs of the invention comprising one or more of the above organic anions or other organic anions which do not comprise a second functional group. Examples of such other organic anions are known in the art and include mono-, di- or polycarboxylates, sulfonates, phosphonates, and sulfates.

Generally, at least 10% of the total amount of intercalating ions in the modified LDH according to the invention will contribute to the organic anion of the invention. Preferably, at least 30%, more preferably at least 60%, and most preferably at least 90% of the total amount of intercalating ions is an organic anion.

The LDH of the invention can also be modified using a silane coupling agent having at least one alkoxysilane group and at least one reactive group, the alkoxysilane group being chemically linked to the layered double hydroxide, the reactive group being chemically linked to the rubber. The reactive group may be the same group as the second functional groups defined above. Examples of such silane coupling agents are bis(3-triethoxysilylpropyl) tetrasulfide (Si69® ex Degussa), bis(3-triethoxysilylpropyl) disulfide, gamma-mercaptopropyl trimethoxysilane (SiSiB® PC2300 ex PCC), and 3-octanoylthio-1-propyl-triethoxysilane (NXT™ ex GE).

The amount of silane coupling agent is such that at least part of the modified LDH is chemically linked to the rubber in the nanocomposite material. If the rubber is a rubber other than a silicone rubber, the amount of silane coupling agent generally is at least 0.5 wt %, preferably at least 1 wt %, and most preferably at least 5 wt %, based on the total weight of the modified LDH, and the amount of silane coupling agent generally is at most 50 wt %, preferably at most 40 wt %, and most preferably at most 30 wt %, based on the total weight of the modified LDH.

If the rubber is a silicone rubber, the amount of silane coupling agent generally is at least 10 wt %, preferably at least 20 wt %, and most preferably at least 30 wt %, based on the total weight of the modified LDH, and the amount of silane coupling agent generally is at most 99 wt %, preferably at most 90 wt %, and most preferably at most 80 wt %, based on the total weight of the modified LDH. In one embodiment of the invention, the LDH is modified with a silane coupling agent and further comprises charge-balancing organic anions, and in particular organic anions comprising a first and a second functional group as defined above.

The amount of LDH of the invention in the nanocomposite material preferably is 0.01-75 wt %, more preferably 0.05-60 wt %, even more preferably 0.1-50 wt %, based on the total weight of the nanocomposite material.

The rubber-LDH nanocomposite material of the invention may further comprise additives commonly used in the art. Examples of such additives are pigments, dyes, UV-stabilizers, heat-stabilizers, anti-oxidants, fillers (such as hydroxy-apatite, silica, silane coupling agents, compatibilizers, oil, waxes, carbon black, glass fibres, polymer fibres, non-intercalated clays, and other inorganic materials), flame retardants, plasticizers, rheology modifiers, cross-linking agents, and degassing agents. A further commonly used additive is extender oil. It is also contemplated to mix the modified LDH with the extender oil before adding this mixture to the rubber. This has the advantage that the modified LDH is dispersed in the oil and can be easily and more uniformly mixed into the rubber.

These optional addenda and their corresponding amounts can be chosen according to need.

The invention further pertains to a masterbatch, i.e. a highly concentrated additive premix, comprising rubber or a rubber precursor and a modified layered double hydroxide comprising a charge-balancing organic ion having a first functional group and a second functional group and/or a silane coupling agent having at least one alkoxysilane group and at least one reactive group, wherein the amount of modified layered double hydroxide is between 10 and 70 wt % and the amount of rubber is between 30 and 90 wt %, based on the total weight of the masterbatch. Preferably, the amount of modified LDH is between 15 and 75 wt %, based on the total weight of the masterbatch, and the amount of rubber or rubber precursor is between 25 and 85 wt %. These masterbatches may comprise LDHs of the invention that are delaminated or exfoliated. However, if the LDH in such masterbatches is not completely delaminated, further delamination may be reached at a later stage, if so desired, when blending the masterbatch with the rubber and/or another rubber or polymer to obtain rubber-based nanocomposite materials. In addition or alternatively, at least part of the organic anions of the modified LDHs may be chemically linked to the rubber or rubber precursor through the second functional group.

The invention further pertains to a process for preparing a rubber precursor or a nanocomposite material in accordance with the invention, the process comprising the steps of:
a1) adding the modified layered double hydroxide, optionally mixed with a first solvent, to a rubber precursor comprising one or more polymers and optionally a second solvent; or
a2) adding the modified layered double hydroxide, optionally mixed with a first solvent, to a rubber composition comprising one or more monomers of a rubber precursor and optionally a second solvent, and polymerizing the monomers to form the rubber precursor;
b) optionally cross-linking the rubber precursor in the presence of a cross-linking agent to form the nanocomposite material; and
c) optionally removing the first and/or second solvents during or after any one of steps a1), a2), and b).

The process of the invention comprises two alternative steps a1) and a2). In step a1) the modified LDH, optionally mixed with a first solvent, can be added to the rubber precursor without a reaction taking place between the modified particulate material and the rubber precursor. Alternatively, the addition of the modified LDH is carried out under such conditions that at least part of the organic anions reacts with the rubber precursor through the second functional groups. Upon curing of the composition resulting from step a1), the remaining organic anions that have not reacted with the rubber precursor may at least partly be chemically linked to the rubber.

In step a2) the modified LDH, optionally mixed with the first solvent, is added to one or more monomers of the rubber precursor, which monomers are subsequently polymerized. Depending on the polymerization conditions and the organic anion chosen, at least part of the organic anion reacts with the monomers during polymerization thereof via the second functional groups, causing the LDH to be chemically linked to the rubber precursor. Alternatively, at least part of the organic anions comprising the second functional groups may react with the rubber precursor upon curing of the precursor in step b), causing the modified LDH to be chemically linked to the rubber composition.

It is noted that exfoliation and/or delamination of the organically modified LDH may occur in any one of steps a1), a2), and b).

In one embodiment of the process of the invention, the modified LDH or the masterbatch is added to the rubber precursor, while the rubber precursor is kept at a temperature at which it is fluid. In this way, it is ensured that the LDH or the masterbatch is easily mixed in the first or the second polymer, enabling a uniform distribution of nanometer-sized LDH particles throughout the polymer within an even shorter time, rendering the process more attractive economically. The mixing and/or compounding steps can be performed in a batch process, e.g. in a Banbury mixer, or in a two-roll mill, or in a continuous mode, e.g. in tube reactors, extruders such as (co-rotating) twin- or single-screw extruders or a Buss Kneader (reciprocating single-screw extruder), and plow mixers.

In the context of the present application the term “compounding” refers to the action of mixing together with sufficient shear stress being applied to the polymer-based mixture to convert at least part of the modified LDH particles of micrometer size into nanometer-sized particles. This shear stress can be applied by mixing the polymer-based mixture in, e.g., a Banbury mixer or in an extruder.

The modified LDH used in the process of the invention may be reduced in size prior to addition in step a1) or a2). The modified LDH may have a d50 value of less than 20 μm and a d90 value of less than 50 μm. Preferably, the d50 value is less than 15 μm and the d90 value is less than 40 μm, more preferably the d50 value is less than 10 μm and the d90 value is less than 30 μm, even more preferably the d50 value is less than 8 μm and the d90 value is less than 20 μm, and most preferably the d50 value is less than 6 μm and the d90 value is less than 10 μm. The particle size distribution can be determined using methods known to the man skilled in the art, e.g. using laser diffraction in accordance with DIN 13320. The use of LDHs having such a smaller particle size distribution enables good mixing of the modified LDH throughout the rubber nanocomposite material as well as an easier exfoliation and/or delamination of the modified LDH.

The particle size distribution of the modified LDH as suitably used in the process of the invention can be obtained by any method known in the art for reducing the particle size of inorganic materials such as LDHs. Examples of such methods are wet milling and dry milling. Alternatively, such modified LDH can be produced during the preparation of the modified LDHs, as is exemplified by WO 02/085787.

The first and the second solvent used in the process of the invention can be any solvent suitable for use in this process and are known to the man skilled in the art. Such first and/or second solvents may be the same or different and are preferably a solvent compatible with the organically modified LDH as well as with the rubber precursor, its monomer and/or the resulting rubber nanocomposite material.

The first and/or second solvents include alcohols, such as methanol, ethanol, isopropanol, and n-butanol; ketones such as methyl amyl ketone, methyl ethyl ketone, methyl isobutyl ketone, and cyclohexanone; esters such as ethyl acetate and butyl acetate; unsaturated acrylic esters such as butyl acrylate, methyl methacrylate, hexamethylene diacrylate, and trimethylol propane triacrylate; aromatic and non-aromatic hydrocarbons such as hexane, petroleum ether, toluene, and xylene; and ethers such as dibutyl ether, tetrahydrofuran (THF), and methyl tert-butyl ether (MTBE).

The rubber precursor prepared with the process of the invention is a precursor of rubber which upon curing or vulcanization can be converted into the rubber. Such rubber precursors as well as the rubbers formed thereof are known to the man skilled in the art.

Examples of rubbers include natural rubber (NR), styrene-butadiene rubber (SBR) polyisoprene (IR), polybutadiene or butyl rubber (BR), polyisobutylene rubber (IIR), halogenated polybutadiene rubber, halogenated polyisobutylene rubber, nitrile butadiene rubber (NBR), hydrogenated nitrile butadiene rubber, styrene-isoprene-styrene (SIS) and similar (hydrogenated) styrenic block copolymers (SBS, hydrogenated SIS, hydrogenated SBS), poly(epichlorohydrin) rubbers (CO, ECO, GPO), silicone rubbers (Q), chloroprene rubber (CR), ethylene propylene rubber (EPM), ethylene propylene diene rubber (EPDM), fluorine rubbers (FKM), ethylene-vinylacetate rubber (EVA), vinyl butadiene rubber, halogenated butyl rubber, polyacrylic rubbers (ACM), polynorbornene (PNR), polyurethanes, and polyester/ether thermoplastic elastomers. Preferred rubbers are natural rubber, SBR, EPDM, halogenated butyl rubber, butadiene rubber, and silicone rubbers.

In one embodiment of the invention, the rubber is a silicone rubber. The production of silicone rubbers is generally known to a person skilled in the art, and is described for example in Chapters 3, 4, and 5 of Silicones, Kirk Othmer Encyclopedia of Chemical Technology, John Wiley & Sons, Inc., online posting date: Dec. 20, 2002. In essence, the production of silicones proceeds via the polymerization of monomers to form a silicone precursor, after which the silicone precursors are cross-linked to form the silicone. The silicone precursors used in the process of the invention are known to the man skilled in the art. It is noted that the silicone precursor preferably is liquid, so that the mixture of the modified particulate material and the first solvent can be easily mixed with the precursor in order to obtain a homogeneous and uniform distribution of the particulate material throughout the silicone precursor.

In another embodiment of the process of the invention, the silicone precursor obtained in either of steps a1) and a2) is cured to form the silicone, e.g. silicone rubber or silicone foam rubber. Such curing typically brings about the formation of a three-dimensional network structure consisting of cross-linked poly-diorganosiloxane chains. Curing generally proceeds via peroxide-induced free-radical processes, via hydrosilylation addition processes using a Group VIII metal (such as Pt and Ru) complex or a supported Group VII metal catalyst, or via condensation reactions. Examples of each of these curing processes can be found in Chapter 5, “Silicone Network Formation” of Silicones, Kirk Othmer Encyclopedia of Chemical Technology, John Wiley & Sons, Inc., online posting date: Dec. 20, 2002. Upon curing of the silicone precursor, silicone rubber or rubber foams can be obtained.

The rubber compositions of the present invention can be suitably applied in tyre manufacture, such as in green tyres, truck tyres, tractor tyres, off-the-road tyres, and aircraft tyres, in winter tyres, in latex products including gloves, condoms, balloons, catheters, latex thread, foam, carpet backings, and rubberized coir and hair, in footwear, in civil engineering products such as bridge bearings, rubber-metal-laminated bearings, in belting and hoses, in non-tyre automotive applications including engine mounts, rubber bearings, seals, grommets, washers, and boots, in wires and cables, and in pipe seals, medical closures, rollers, small solid tyres, mountings for domestic and commercial appliances, rubber balls and tubing, milking inflations and other agricultural-based applications.

If the rubber composition is a silicone composition comprising silicone rubber and the modified particulate material in accordance with the present invention, these rubber compositions can be suitably applied in coating products including pressure-sensitive adhesives, plastic hardcoats, and paper release coatings, in fibre finishing applications including textile and hair care applications, sealants, adhesives, encapsulants, and solar cell units.

In one embodiment of the invention the modified layered double hydroxide is used in a rubber composition for tyres, in particular for car tyres. The rubber in the rubber composition can be any rubber conventionally used in tyres. Examples of such rubbers are natural rubber, styrene-butadiene rubber, butadiene rubber, vinyl-butadiene rubber, and halogenated butyl rubber. Also mixtures of these rubbers are commonly used.

The rubber composition according to the invention can be used in any part of the tyre where an inorganic filler, such as carbon black or precipitated silica, is conventionally used. In particular, the rubber composition can be used in the undertread or tread base, the tread, the sidewall, the rim cushion, the inner layer, the carcass, the apex, the bead, and the belt layer. It is also envisaged to use a combination of the modified particulate material of the invention and a conventional inorganic filler like carbon black or precipitated silica. The use of the modified layered double hydroxide enables a reduction of the total amount of inorganic filler in the rubber composition, while maintaining similar or improved mechanical properties. The use of the rubber composition of the present invention in tyres may improve the mechanical and dynamic properties of the tyre, it may further enhance the bonding or adhesion between different rubbers, e.g. in different parts of the tyre, or between rubber and metal (e.g. in metal cords), or between rubber and fibres. The rubber used in the tread—usually solution SBR rubber—can be replaced by a cheaper rubber, e.g. emulsion SBR rubber, without loss of mechanical or dynamic properties of the tread. The modified LDH of the invention also causes the rubber to have an improved puncture resistance.

In a preferred embodiment, the modified layered double hydroxide is modified with a coupling agent comprising a vulcanizable group, or with an organic anion having a vulcanizable group. Such a coupling agent can be a silane coupling agent like bis(3-triethoxysilylpropyl) tetrasulfide (Si69® ex Degussa), bis(3-triethoxysilylpropyl) disulfide, gamma-mercaptopropyl trimethoxysilane (SiSiB® PC2300 ex PCC), and 3-octanoylthio-1-propyltriethoxysilane (NXT™ ex GE). Examples of vulcanizable organic anions are 12-hydroxystearic acid, 12-chloro-stearic acid, 12-aminododecanoic acid, epoxidized fatty acids, mercapto-propionic acid, oleic acid, conjugated unsaturated fatty acids, dithiodipropionic acid, p-hydroxybenzoic acid, and maleimidopropionic acid.

The advantage of these modified layered double hydroxides is that the time needed to produce a tyre, in particular a green tyre, can be reduced. Moreover, the dimensional stability of the uncured tyre as well as the final tyre will improve. In conventional processes the precipitated silica is added to the rubber together with a coupling agent like bis(3-triethoxysilylpropyl) tetrasulfide, the rubber composition is allowed to react at elevated temperatures, the ethanol produced is removed, and an uncured tyre is obtained, which is then cured at a higher temperature to start vulcanization and to form the tyre. The use of the modified layered double hydroxides of the invention, in particular the layered double hydroxides modified with the coupling agent having a vulcanizable group, in the production of tyres has the advantage that the coupling agent is already attached to the particulate material and no ethanol is formed, leading to a reduction in processing time which may enhance the production rate of (green) tyres. If a combination of the modified layered double hydroxide and the conventional filler such as precipitated silica is used, a coupling agent may be added separately to the mixture so that it can react with the precipitated silica. The modified layered double hydroxide may be added to the rubber in the form of a (colloidal) suspension in a suitable solvent (containing no or hardly any water), or it may be added in an extender oil or as solids. In the case of an extender oil or solids, no solvent has to be removed, leading to a further reduction in processing time and to an improved process safety.

The invention further pertains to the use of the rubber composition in accordance with the invention in solar cell units. In a preferred embodiment the rubber of the rubber composition is a transparent rubber. The transparent rubber is a rubber which is transparent to visible light. Examples of such transparent rubbers are polyurethane, ethylene vinyl-acetate rubber, and silicone rubber. Preferably, the transparent rubber is a silicone rubber. The solar cell unit can be any solar cell unit known in the art. Examples of such solar cell units are crystalline Si solar cells, amorphous silicon solar cells, crystalline silicon thin film solar cells, and compound semiconductor solar cells based on, e.g., CdTe, CuInSe₂, Cu(In, Ga)(Se, S)₂ (so called CIGS), and Grätzel cells. Further details can be gleaned from F. Pfisterer (“Photovoltaic Cells”, Chapter 4: “Types of Photovoltaic Cells,” Ullmann's Encyclopedia of Industrial Technology, online posting date: Jun. 15, 2000).

The rubber composition used in solar cell units may serve to connect two juxtaposed layers in the unit. The advantage of the rubber composition of the present invention is its transparency to visible light, which enables application at a position where light travels through the rubber composition before reaching the part of the cell where the light is converted into electrical energy. The rubber composition may also serve to connect the solar cell unit to a substrate, e.g. a plate or a roof tile. In such cases the rubber composition does not have to be transparent. Generally, the rubber composition exhibits improved mechanical properties over conventional rubber compositions.

One embodiment of the present invention pertains to a solar cell unit comprising a back electrode, a photovoltaic layer, a front electrode, and a transparent top layer wherein a layer of the rubber composition of the invention is present in between the front electrode and the transparent top layer. As indicated above, the rubber of the rubber composition preferably is a transparent rubber, and most preferably the rubber is a silicone rubber. The rubber composition serves as adhesive or binding layer for the transparent top layer and the front electrode. Due to the aforementioned improved mechanical properties, the adhesive power and the tear strength of the rubber composition are increased and the solar cell unit (in use) is capable of better withstanding weather influences or other mechanical forces to which it is to be exposed. Consequently, the life-time of the solar cell unit is increased. Moreover, the rubber composition of the invention is transparent to visible light, which brings about an improved light yield and solar energy recovery as compared to solar cell units comprising a rubber composition with particles having sizes in the range of or exceeding the visible light wavelengths, i.e. between 400 and 800 nm.

Solar cell units comprising a back electrode, a photovoltaic layer, a front electrode, and a transparent top layer are known to the man skilled in the art. Generally, the back electrode, a photovoltaic layer, a front electrode, and a transparent top layer are provided in layers one on top of the other. A more detailed description of such solar cell units can be found in EP 1 397 837 and EP 1 290 736, which specific descriptions of the back electrode, the photo-voltaic layer, the front electrode, and the transparent top layer are incorporated herein by reference.

The invention is illustrated by the following examples.

### EXAMPLES

In the examples, a commercially available saturated fatty acid mixture and an unsaturated fatty acid mixture were used as received. The saturated fatty acid mixture was Kortacid® PH05, a blend of palmitic and stearic acid, which was supplied by Oleochemicals GmbH, a company of Akzo Nobel Chemicals. The unsaturated fatty acid mixture was Kortacid® PZ05, a distilled palmitic oil, which was supplied by Oleochemicals GmbH, a company of Akzo Nobel Chemicals.

### Example 1

50 grams of magnesium oxide (Zolitho® 40, ex Martin Marietta Magnesia Specialties LLC) and 39 grams of aluminium trihydroxide (Alumill F505) were mixed in 648 grams of demineralized water and ground to an average particle size (d₅₀) of 2.5 μm. The slurry was fed to an oil-heated autoclave equipped with a high-speed stirrer and heated to 80° C. Then 102 grams of Kortacid® PH05 were added to the autoclave over a period of 15 minutes. Before addition, the fatty acid blend was heated to 80° C. After the acid addition, the autoclave was closed and heated to 170° C. and kept there for 1 hour. Then the autoclave was cooled to about 40° C. and the resulting slurry was removed. The slurry was then centrifuged at 2,000 rpm for about 10 minutes. The liquid was decanted and the solids were dried under vacuum in an oven overnight at 80° C.

The resulting hydrotalcite-like clay comprising the fatty acids blend was analyzed with X-ray diffraction to determine the inter-gallery spacing or d-spacing. The XRD pattern of the hydrotalcite-like clay as prepared above shows minor hydrotalcite-related non-(hk0) reflections, indicating intercalation of the anionic clay. The intercalate exhibits a characteristic d(00l) value of 29 Å.

### Example 2

A modified layered double hydroxide was prepared according to Example 1, except that Kortacid® PZ05 was used instead of Kortacid® PH05.

### Example 3

The modified layered double hydroxide of Example 1 was milled using a Hosokawa Alpine 50 ZPS circoplex multi-processing mill. The resulting powders had a d50 value of 1.7 μm and a d90 value of 3.4 μm, as determined in accordance with DIN 13320.

Masterbatches comprising 50 wt % of the powdered modified LDH of Example 1 and 50 wt % of Vistalon® 2504N (an EPDM rubber precursor ex ExxonMobil) were prepared. The EPDM rubber precursor was fed to an open two-roll mill (Dr Collin two-roll mill with dimensions of 110 mm in diameter and a length of 250 mm and a variable nip setting from 0.2-5 mm), after which the powdered modified LDH was added over a period of 10 minutes. The two-roll mill was operated at a temperature of between 50 and 70° C. with a friction factor of 1.2. The resulting masterbatch was diluted with the same rubber precursor in an internal batch mixer (Rheocord® 9000 fitted with the 60 CC mixing chamber Rheomix® 600 containing roller rotors) at 60° C. and 50 rpm for 30 minutes. In this way, three samples with varying amounts of the modified LDH of Example 1 were prepared, viz. 4, 6 or 8 wt % of the modified LDH, based on the total weight of the EPDM rubber precursor and the modified LDH. The samples are denoted as Examples 3A (4 wt %), 3B (6 wt %), and 3C (8 wt %).

In a two-roll mill, about 50 grams of each of the samples were then mixed with 1.35 grams of dicumyl peroxide (Perkadox® BC-ff ex Akzo Nobel). The two-roll mill was operated at a temperature between 50 and 70° C. with a friction factor of 1.2.

The thus obtained mixture was finally compression moulded into sheets of 2 mm thickness at 170° C. and 400 kN for 15 minutes so as to obtain a nanocomposite material of EPDM rubber.

For reference purposes, an EPDM rubber was prepared using the above method, except that no modified LDH was added to the rubber.

### Example 4

The procedure of Example 3 was repeated, except that the modified LDH of Example 2 was used instead of the modified LDH of Example 1, and the ground powder had a d50 value of 1.7 μm and a d90 value of 3.4 μm, as determined in accordance with DIN 13320. The samples are denoted as Examples 4A (4 wt %), 4B (6 wt %), and 4C (8 wt %).

Tensile tests and tear strength tests were performed on a Zwick Z010 tensile tester in accordance with ISO 37-2 and ISO 34, respectively. The results of the various nanocomposite materials comprising EPDM rubber are shown in Table 1 below.

TABLE 1

| | Pure | Examples | | | | | |
|---|---|---|---|---|---|---|---|
| Properties | rubber | 3A | 4A | 3B | 4B | 3C | 4C |
| Stress at break | 1.4 | 1.9 | 2.1 | 1.9 | 2.5 | 2.2 | 2.3 |
| (MPa) | | | | | | | |
| Elongation at break | 122 | 161 | 150 | 169 | 175 | 209 | 194 |
| (%) | | | | | | | |
| Tear strength (N) | 7.8 | 11.1 | 12.5 | 11.5 | 13.9 | 12.4 | 14 |

From the Table above it can be deduced that the EPDM rubber nanocomposite materials of Examples 4A, 4B, and 4C (which are in accordance with the invention) show improved physical properties, in particular an improved stress at break and tear strength, compared to the nanocomposite materials of Examples 3A, 3B, and 3C (which are not in accordance with the invention), respectively.

1. A nanocomposite material comprising rubber, and a modified layered double hydroxide comprising at least one of:
a charge-balancing organic ion having a first functional group and a second functional group, wherein at least part of the organic ion is chemically linked to the rubber through the second functional group; and
a silane coupling agent having at least one alkoxysilane group and at least one reactive group, at least one alkoxysilane group being chemically linked to the layered double hydroxide, at least one reactive group being chemically linked to the rubber.

2. The nanocomposite material according to claim 1 wherein the second functional group is selected from the group consisting of acrylate, methacrylate, hydroxyl, chloride, amine, epoxy, thiol, vinyl, disulfides, polysulfides, carbamate, ammonium, sulfonic, sulfinic, sulfonium, phosphonium, phosphinic, isocyanate, mercapto, hydroxyphenyl, hydride, acetoxy, and anhydride.

3. The nanocomposite material according to claim 1 wherein the modified layered double hydroxide further comprises a second organic anion as charge-balancing ion, the second organic anion being only physically linked to the rubber.

4. The nanocomposite material according to claim 1 wherein the rubber is selected from the group consisting of natural rubber, SBR, EPDM, halogenated butyl rubber, butadiene rubber, and silicone rubbers.

5. A masterbatch comprising rubber or a rubber precursor; and a modified layered double hydroxide comprising at least one of a charge-balancing organic ion having a first functional group and a second functional group, and a silane coupling agent having at least one alkoxysilane group and at least one reactive group, wherein the amount of modified layered double hydroxide is between 10 and 70 wt % and the amount of rubber is between 30 and 90 wt %, based on the total weight of the masterbatch.

6. A process for preparing a rubber precursor or a nanocomposite material according to claim 1, the process comprising the steps of:
a1) adding the modified layered double hydroxide, optionally mixed with a first solvent, to a rubber precursor comprising one or more polymers and optionally a second solvent; or
a2) adding the modified layered double hydroxide, optionally mixed with a first solvent, to a rubber composition comprising one or more monomers of a rubber precursor and optionally a second solvent, and polymerizing the monomers to form the rubber precursor;
b) optionally cross-linking the rubber precursor in the presence of a cross-linking agent to form the nanocomposite material; and
c) optionally removing the first and/or second solvents during or after any one of steps a1), a2), and b).

7. A tire comprising the nanocomposite material according to claim 1.

8. A solar cell unit comprising the nanocomposite material according to claim 1, wherein the rubber is a silicone rubber.

9. The nanocomposite material according to claim 2 wherein the modified layered double hydroxide further comprises a second organic anion as charge-balancing ion, the second organic anion being only physically linked to the rubber.

10. The nanocomposite material according to claim 2 wherein the rubber is selected from the group consisting of natural rubber, SBR, EPDM, halogenated butyl rubber, butadiene rubber, and silicone rubbers.

11. The nanocomposite material according to claim 3 wherein the rubber is selected from the group consisting of natural rubber, SBR, EPDM, halogenated butyl rubber, butadiene rubber, and silicone rubbers.

12. A process for preparing a rubber precursor or a nanocomposite material according to claim 2, the process comprising the steps of:
a1) adding the modified layered double hydroxide, optionally mixed with a first solvent, to a rubber precursor comprising one or more polymers and optionally a second solvent; or
a2) adding the modified layered double hydroxide, optionally mixed with a first solvent, to a rubber composition comprising one or more monomers of a rubber precursor and optionally a second solvent, and polymerizing the monomers to form the rubber precursor;
b) optionally cross-linking the rubber precursor in the presence of a cross-linking agent to form the nanocomposite material; and
c) optionally removing the first and/or second solvents during or after any one of steps a1), a2), and b).

13. A process for preparing a rubber precursor or a nanocomposite material according to claim 3, the process comprising the steps of:
a1) adding the modified layered double hydroxide, optionally mixed with a first solvent, to a rubber precursor comprising one or more polymers and optionally a second solvent; or
a2) adding the modified layered double hydroxide, optionally mixed with a first solvent, to a rubber composition comprising one or more monomers of a rubber precursor and optionally a second solvent, and polymerizing the monomers to form the rubber precursor;
b) optionally cross-linking the rubber precursor in the presence of a cross-linking agent to form the nanocomposite material; and
c) optionally removing the first and/or second solvents during or after any one of steps a1), a2), and b).

14. A process for preparing a rubber precursor or a nanocomposite material according to claim 4, the process comprising the steps of:
a1) adding the modified layered double hydroxide, optionally mixed with a first solvent, to a rubber precursor comprising one or more polymers and optionally a second solvent; or
a2) adding the modified layered double hydroxide, optionally mixed with a first solvent, to a rubber composition comprising one or more monomers of a rubber precursor and optionally a second solvent, and polymerizing the monomers to form the rubber precursor;
b) optionally cross-linking the rubber precursor in the presence of a cross-linking agent to form the nanocomposite material; and
c) optionally removing the first and/or second solvents during or after any one of steps a1), a2), and b).

15. A tire comprising the nanocomposite material according to claim 2.

16. A tire comprising the nanocomposite material according to claim 7, wherein the rubber is a natural rubber or SBR.

17. A tire comprising the nanocomposite material according to claim 15, wherein the rubber is a natural rubber or SBR.

18. A solar cell unit comprising the nanocomposite material according to claim 2, wherein the rubber is a silicone rubber.

19. A solar cell unit comprising the nanocomposite material according to claim 3, wherein the rubber is a silicone rubber.

20. A solar cell unit comprising the nanocomposite material according to claim 4, wherein the rubber is a silicone rubber.
